(19) United States
(12) Patent Application Publication
(10) Pub. No.: US 2002/0180780 A1
(43) Pub. Date: Dec. 5, 2002

(54) Image data providing apparatus, and image data providing program storage medium

(75) Inventor: Hachiro Honda, Kanagawa (JP)

Correspondence Address: SUGHRUE, MION, ZINN, MACPEAK & SEAS, PLLC, 2100 Pennsylvania Avenue, N.W., Washington, DC, 20037-3202, US

(73) Assignee: FUJI PHOTO FILM CO., LTD.

(21) Appl. No.: 10/112,854

(22) Filed: Apr. 2, 2002

(30) Foreign Application Priority Data
Apr. 3, 2001 (JP) 2001-104077

(51) Int. Cl. G09G 5/00; G06F 15/16

(52) U.S. Cl. 345/738; 345/748; 345/780; 709/219

(57) ABSTRACT

In an image data providing apparatus, when a retrieval server receives a request of a supply for image data from a client, the retrieval server requests of the client utilization information representative of a utilization form estimated on an image represented by the image data required by the request in exchange for a supply for image data. And when the retrieval server receives the requested utilization information from the client, the retrieval server provides image data.

### BACKGROUND OF THE INVENTION

1. Field of the Invention

The present invention relates to an image data providing apparatus for providing image data representative of an image via a communication network, and an image data providing program storage medium storing an image data providing program which causes a computer to operate as such an image data providing apparatus when the image data providing program is incorporated into the computer.

2. Description of the Related Art

Hitherto, there is known an image data providing apparatus for providing image data via a communication network such as an Internet and a LAN. Such an image data providing apparatus is applicable to various fields as technology of communications and the like advance.

For example, a high definition of image used for a printed matter is created in such a manner that a reversal film on which the image came out is transferred from a provider of the image to a design company for a printed matter, the image coming out on the reversal film is read by a scanner and converted into image data, and the image is formed in accordance with the image data. There is considered a service that such image data representative of the high definition of image is provided via a communication network through an image data providing apparatus.

A provider, who provides images through such a service, is for example a maker of goods. And the images to be provided are images of goods. In many cases, the maker of the goods has image data representative of a high definition of image on which goods came out beautiful, and a good image quality of image is readily available through the above-mentioned service to demanders of images such as design companies and publishers. That is, the above-mentioned service is of benefit to demanders of images. On the other hand, in the event that a high definition of image, which is provided through the above-mentioned service, is often utilized for many printed matters, it may be commercial for the goods. Thus, this service is of benefit to the provider too.

However, as a utilization form in which after a demander, who desires an offer of an image from a provider, receives the offer of the image, the image is utilized, there are various forms. Thus, even if a number of images are provided to demanders through the above-mentioned service, a number of images thus provided don't always appear widely on the printed matters.

For this reason, the provider desires to grasp the utilization form of the images provided to the demanders through the above-mentioned service so as to supply the image according to the utilization form.

Such a situation generally widely occurs in a case where the provided images are utilized on a secondary basis by a demander, not occurring only in a case where images to be utilized for printed matters are provided.

### SUMMARY OF THE INVENTION

In view of the foregoing, it is an object of the present invention to provide an image data providing apparatus capable of grasping a utilization form of the provided images, and an image data providing program storage medium storing an image data providing program which causes a computer to operate as such an image data providing apparatus when the image data providing program is incorporated into the computer.

To achieve the above-mentioned object, the present invention provides an image data providing apparatus for providing image data representative of an image via a communication network comprising:

a utilization information request section for requesting of a request source generated a request of supply of image data, upon receipt of the request via the communication network, utilization information representative of a utilization form estimated on an image represented by image data requested by the request; and

a data providing section for providing image data required by the request generated from the request source, upon receipt of the utilization information requested by said utilization information request section from the request source, via the communication network to the request source.

According to the image data providing apparatus of the present invention as mentioned above, image data is provided in exchange for utilization information. Thus, a provider of images is able to grasp the utilization form in accordance with the utilization information.

In the image data providing apparatus according to the present invention as mentioned above, it is preferable that the image data is created by an input device for reading an original image to generate image data, and

said data providing section provides a profile defining an association between a color of the original image and a value of the image data in said input device, together with the image data.

A profile of an input device is necessary for properly reproducing a color of an image represented by image data. Supplying of the profile appending it to the image data makes it possible to expect utilization promotion of image data.

In the image data providing apparatus according to the present invention as mentioned above, it is preferable that said image data providing apparatus further comprises:

a data processing section for applying data processing to image data in accordance with an instruction from the request source, and

that said data providing section provides the request source with the image data subjected to the data processing by said data processing section.

It is considered that in many cases it is difficult for a demander to apply data processing corresponding to processing of images to image data. Accordingly, supplying of the image data subjected to such data processing makes it possible to expect further utilization promotion of image data.

In the image data providing apparatus according to the present invention as mentioned above, it is preferable that said image data providing apparatus further comprises:

a data conversion section for performing a data conversion between first image data in which a color is represented by a first color space and second image data in which a color is represented by a second color space in accordance with a predetermined instruction from the request source, and

that said data providing section provides the request source with the image data subjected to the data conversion by said data conversion section.

Here, as the first color space and the second color space, there are considered, for example, a three-dimensional color space in which RGB three colors and CMY three colors are established as primary colors, a four-dimensional color space in which CMYK four colors are established, and a CIELAB color space.

Also as to the data conversion as mentioned above, it is considered that in many cases it is difficult for a demander to perform such a data conversion. Accordingly, supplying of the image data subjected to such a data conversion makes it possible to expect further utilization promotion of image data.

To achieve the above-mentioned object, the present invention provides an image data providing program storage medium storing an image data providing program which causes a computer to operate as an image data providing apparatus for providing image data representative of an image via a communication network, said image data providing apparatus comprising:

a utilization information request section for requesting of a request source generated a request of supply of image data, upon receipt of the request via the communication network, utilization information representative of a utilization form estimated on an image represented by image data requested by the request; and

a data providing section for providing image data required by the request generated from the request source, upon receipt of the utilization information requested by said utilization information request section from the request source, via the communication network to the request source.

Incidentally, with respect to the image data providing program referred to in the present invention, there is simply shown a basic form only. This is, however, for the purpose of avoiding redundancy and it is noted that the image data providing program referred to in the present invention includes not only the image data providing program of the above-mentioned basic form, but also the image data providing program of the various types of modified forms corresponding to the various types of modified forms of the above-mentioned image data providing apparatus.

### BRIEF DESCRIPTION OF THE DRAWINGS

FIG. 1 is a view of an image data providing apparatus according to an embodiment of the present invention.

FIG. 2 is a flowchart useful for understanding an operation of a retrieval server and an operation of a client.

FIG. 3 is a view showing a top page of a site.

FIG. 4 is a view showing a registration screen for registering new members.

FIG. 5 is a view showing a retrieval screen.

FIG. 6 is a view showing a display screen on which a retrieval result is displayed.

FIG. 7 is a view showing a designation screen for designating conversion and processing conditions.

FIG. 8 is a view showing an example of a sample image.

FIG. 9 is a view showing an inquiry screen for a download.

### DETAILED DESCRIPTION OF PREFERRED EMBODIMENTS

Embodiments of the present invention will be described with reference to the accompanying drawings.

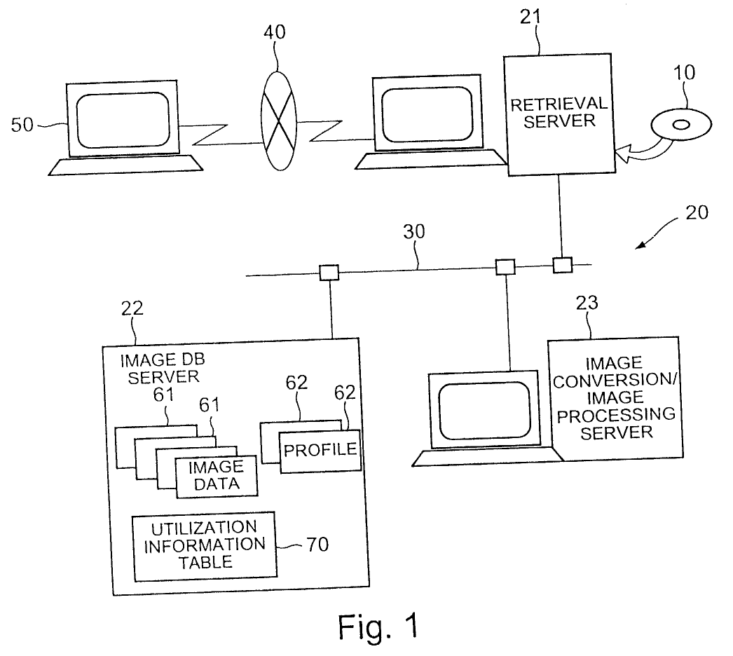

FIG. 1 is a view of an image data providing apparatus according to an embodiment of the present invention.

A CD-ROM 10 shown in FIG. 1 stores therein an image data providing program which causes a retrieval server 21 to operate as an image data providing apparatus according to an embodiment of the present invention. When the image data providing program stored in the CD-ROM 10 is installed on the retrieval server 21 and executed, the retrieval server 21 operates as the image data providing apparatus according to an embodiment of the present invention.

Connected via a LAN 30 to the retrieval server 21 are an image database server 22, and an image conversion and image processing server 23. A site 20 comprises the retrieval server 21, the image database server 22, and the image conversion and image processing server 23. The site 20 also corresponds to the embodiment of the preset invention. According to the present invention, as image data to be provided there are considered various types of image data. By way of example, in the site 20, it is assumed that image data representative of an image of goods to be used in commercial advertisement is provided. A manager for the site 20 receives from a plurality of makers a high quality of image data of goods manufactured by those makers. A user utilizing the site 20 is, for example, a design company and a sales company of goods.

The retrieval server 21 is connected via a communication network 40 to a client 50. The client 50 is loaded with a browser to access to various sites via the communication network 40. The retrieval server 21 serves as an inlet of the site 20 comprising the retrieval server 21, the image database server 22, and the image conversion and image processing server 23.

The image database server 22 stores therein image data 61 provided by the retrieval server 21 for various sorts of goods. Those image data are generated through reading of an original image by input devices such as a scanner and a digital still camera. The image database server 22 also stores therein a profile 62, which defines an association between a color of the original image and a value of the image data in the respective input device. Further, the image database server 22 also stores therein a table 70 which describes utilization information representative of a utilization form in which an image represented by the image data 61 provided by the retrieval server 21 is utilized.

The image conversion and image processing server 23 receives a predetermined instruction issued from the client 50 via the communication network 40 and the retrieval server 21, and performs a conversion of data format of the image data 61 and an image processing for an image represented by the image data 61 in accordance with the instruction.

The retrieval server 21 obtains the image data 61 from the image database server 22 in accordance with a request from the client 50 for the image data 61, and provides the client 50 with the image data 61 together with the profile of the input device in which the image data 61 is created. As will be described later, however, prior to providing the image data 61, the retrieval server 21 requires of the client 50 utilization information representative of utilization form of an image represented by the image data 61, and provides the image data 61 in exchange for a reply of the utilization information. The utilization information is described in the table 70 of the image database server 22.

While FIG. 1 simply shows only one image database server 22 and only one image conversion and image processing server 23, it is noted that a site, in which a plurality of image database servers 22 and a plurality of image conversion and image processing servers 23 are connected to the retrieval server 21, also corresponds to an image data providing apparatus according to an embodiment of the present invention.

Hereinafter, there will be described an operation of a retrieval server referring to flowcharts and drawings.

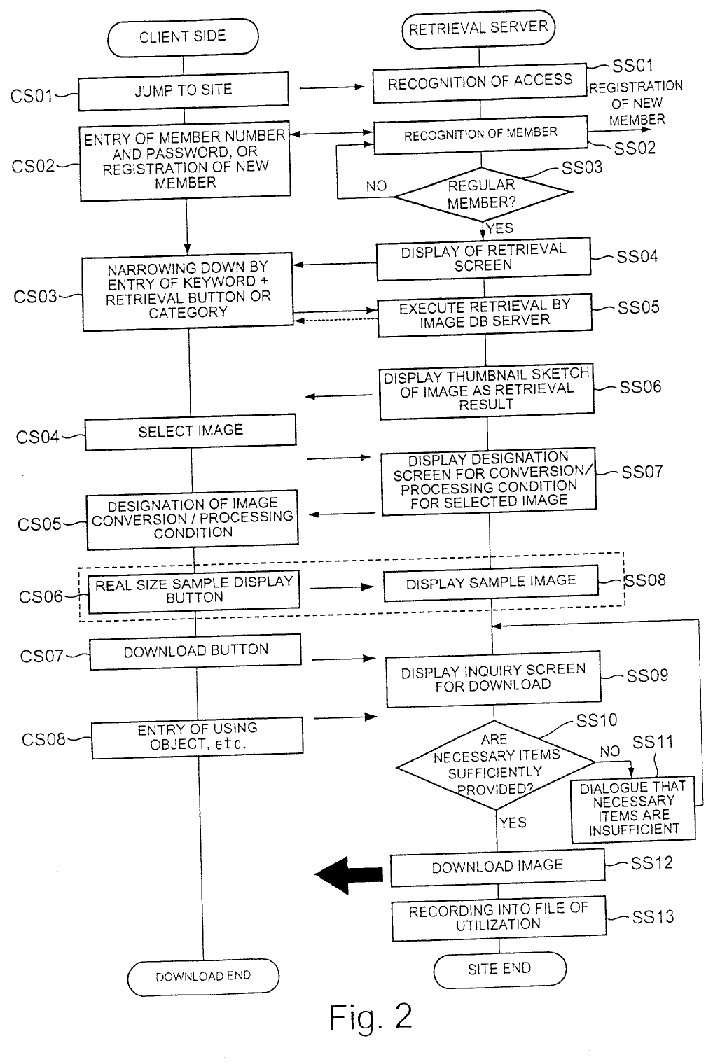

FIG. 2 is a flowchart useful for understanding an operation of a retrieval server and an operation of a client. This flowchart corresponds to an image data providing program stored in an image data providing program storage medium according to an embodiment of the present invention.

First, when a user operates the client 50 (cf. FIG. 1), a destination of access of the client jumps to the site 20 (a step CS01), so that the retrieval server 21 is accessed via the communication network 40.

When the retrieval server 21 recognizes the access from the client 50 (a step SS01), the retrieval server 21 causes the browser loaded on the client 50 to display the top page of the site 20 so that the procedure of recognition of members is performed (a step SS02).

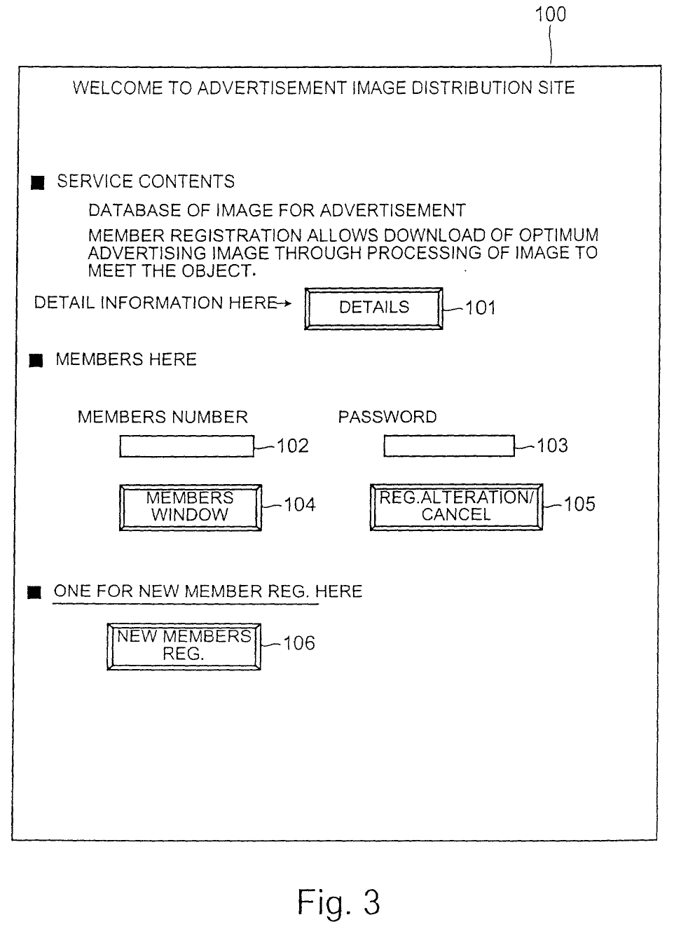

FIG. 3 is a view showing a top page of a site.

The top page 100 is provided with a detail display button 101. When the detail display button 101 is clicked, the detailed explanation of the service contents in the site 20 shown in FIG. 1 is displayed. The site 20 is of providing the registered members with image data. The top page 100 is further provided with a member number entry column 102 for entering member numbers, a password entry column 103 for entering passwords, a member window button 104 for instructing an execution of certification by the member number and the password entered into the member number entry column 102 and the password entry column 103, and a registration alteration/cancel button 105 for instructing an alteration of a registration and a cancellation of members specified by the member number and the password.

Further, the top page 100 is provided with a new member registration button 106 for instructing a registration of a user of the client 50 shown in FIG. 1 as a new member.

In the event that the user, who utilizes the client 50, has been already registered as a member, a member number and a password are entered through the member number entry column 102 and the password entry column 103. On the other hand, in the event that the user is not registered as a member, the new member registration button 106 is clicked (a step CS02 in FIG. 2).

In the event that the new member registration button 106 is clicked, the retrieval server 21 in FIG. 1 causes the browser to display the registration screen for registering a new member so that a registration of the new member is performed (a step SS02 in FIG. 2: a new member registration).

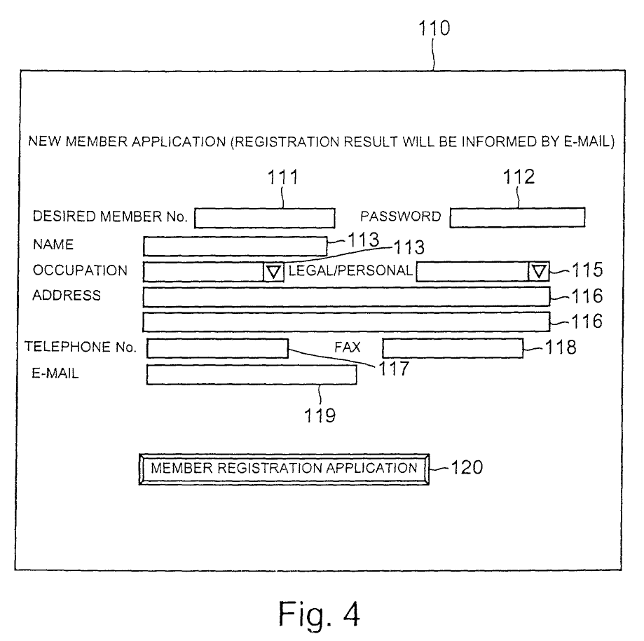

FIG. 4 is a view showing a registration screen for registering new members.

A registration screen 110 is provided with a member number entry column 111 for entering a member number which a user to be registered as a new member desires, a password entry column 112 for entering passwords, a name entry column 113 in which names of new members are entered, an occupation selection box 114 in which an occupation of a new member is selectively entered, a corporation and private selection box 115 in which a selection between a corporate member and a private member is performed, an address entry column 116 in which an address of a new member is entered, a telephone number entry column 117 in which a telephone number of a new member is entered, a FAX number entry column 118 in which a FAX number of a new member is entered, and an e-mail number entry column 119 in which an e-mail number of a new member is entered.

When a member registration application button 120 is clicked after necessary matters for members registration are entered to the respective entry columns or selected by the respective selection boxes, the registration as a new member is performed, so that the top page 100 in FIG. 3 is displayed again.

In the event that the member window button 104 shown in FIG. 3 is clicked after the member number and password are entered in the step CS02 in FIG. 2, there is performed certification as to whether it is concerned with a proper member (a step SS03 in FIG. 2). In the event that the entered member number and password are not coincident with the member number and the password of the proper member (the step SS03 in FIG. 2: No), the process returns to the step SS02 so that the procedure of the member recognition is carried out again.

In the event that the entered member number and password are coincident with the member number and the password of the proper member (the step SS03 in FIG. 2: Yes), the retrieval server 21 in FIG. 1 causes the browser to display the retrieval screen for retrieving image data (a step SS04 in FIG. 2).

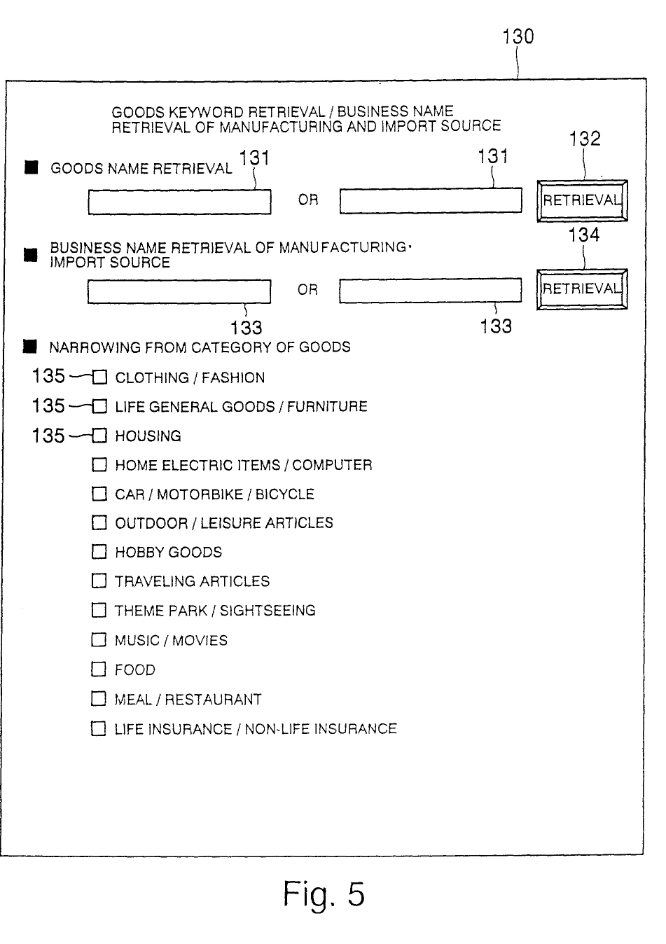

FIG. 5 is a view showing a retrieval screen.

A retrieval screen 130 is provided with two goods name entry columns 131 in which goods names are entered as a keyword when an image is retrieved with a goods name, and a retrieval button 132 for instructing a retrieval by the goods name.

The retrieval screen 130 is further provided with two enterprise name entry columns 133 in which enterprise names are entered as a keyword when an image is retrieved with an enterprise name with which goods are manufactured or imported, and a retrieval button 134 for instructing a retrieval by the enterprise name.

The retrieval screen 130 is still further provided with 13 check boxes 135 associated with 13 sorts of categories of goods, respectively. In the retrieval by the goods name and the enterprise name, there is performed a retrieval in which of the 13 check boxes 135 checked one is narrowed down to the associated category.

When the retrieval button is clicked on the retrieval screen 130 after an entry of the keyword and an instruction of a narrowing down retrieval by the check of the check boxes 135 are performed (a CS03 in FIG. 2), the retrieval server 21 in FIG. 1 retrieves image data associated with the keyword, using the retrieval function of the image database server (an SS05 in FIG. 2). And the retrieval server 21 causes the browser to display a result of retrieval (an SS06 in FIG. 2).

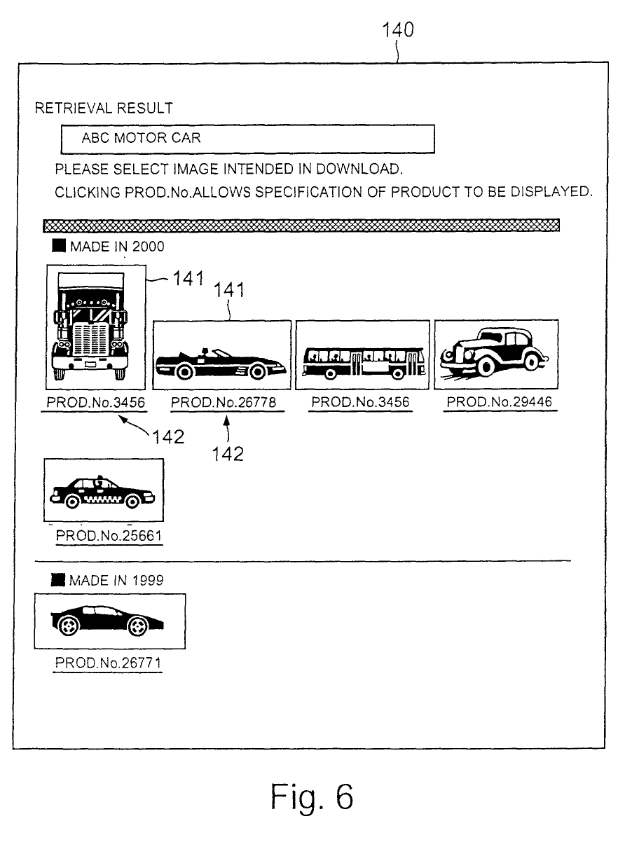

FIG. 6 is a view showing a display screen on which a retrieval result is displayed.

On a display screen 140, a thumbnail sketch 141 of an image represented by image data detected by the retrieval is displayed together with a product number 142 represented by the image. When a character string of the product number 142 is clicked, a detailed specification of the product is displayed.

When a member selects a desired image referring to the thumbnail sketches 141 displayed on the display screen 140 and clicks the thumbnail sketch of the selected image (a step CS04 in FIG. 2), the retrieval server 21 in FIG. 1 causes the browser to display a designation screen for designating an image processing for the selected image and conditions for data conversion to image data representative of the image (a step SS07 in FIG. 2).

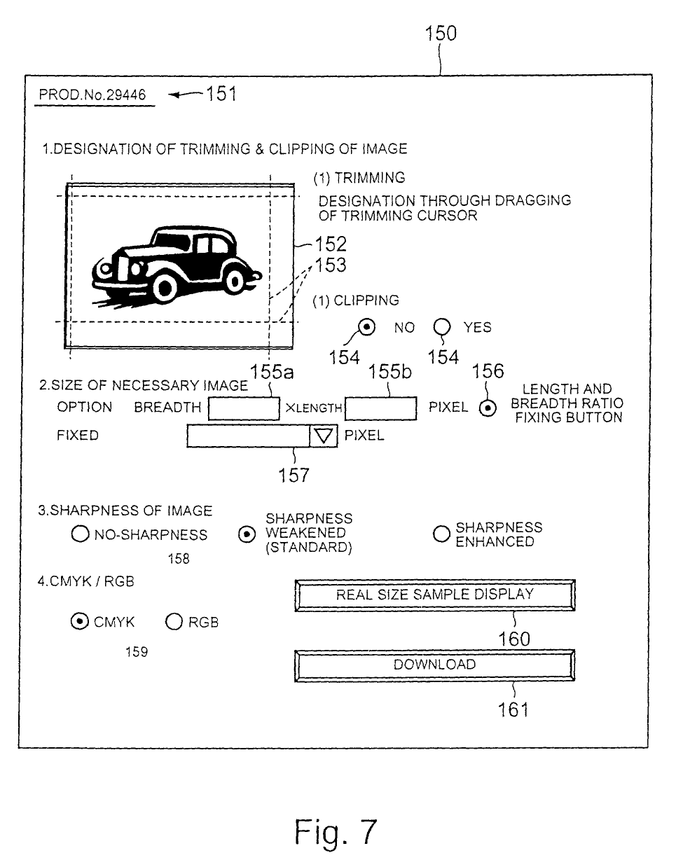

FIG. 7 is a view showing a designation screen for designating conversion and processing conditions.

A designation screen 150 is for designating conversion conditions of image data format and conditions of image processing to the image conversion and image processing server 23 shown in FIG. 1, which serves both as an example of the data processing section and an example of the data conversion section referred to in the present invention.

On the designation screen 150, there are displayed a product number 151 of goods represented by the image selected by the member and a thumbnail sketch image 152 of the image.

On the thumbnail sketch image 152, there is displayed with broken lines cursors 153 for a trimming in which unnecessary background portions of an image are cut to balance the goods in the image. In the event that a member desires only a part of the image shown in the thumbnail sketch image 152, dragging the cursor 153 by the mouse may designate a trimming limit of the trimming. Further, on the designation screen 150, there are provided radio buttons 154 for a selection as to whether a clipping processing of clipping only the goods portion in the image along the contours of the goods.

According to the present embodiment, when a member designates a desired size of image, there is provided image data representative of the image of the size. For this reason, the designation screen 150 in FIG. 7 is provided with a breadth size entry column 155a and a length size entry column 155b, which allow a member to enter an optional image size. The designation screen 150 is further provided with a length and breadth ratio fixing button 156 for selecting as to whether a length and breadth ratio of the image is fixed to a length and breadth ratio of the original image. In the event that the length and breadth ratio fixing button 156 is in a selection state, when an entry is made in a value into either one of the breadth size entry column 155a and the length size entry column 155b, an automatic computation is made in such a manner that a value for another takes a length and breadth ratio of the original image.

The designation screen 150 is further provided with a fixed size selection box 157 in which a selective size designation is performed presupposing a plurality of sizes previously prepared, instead of the designation of sizes by the breadth size entry column 155a and the length size entry column 155b. As the sizes designated by the fixed size selection box 157, there are considered, for example, a vertical size such as 100×141, 141×200, a horizontal size such as 141×100, 200×141, and a square size such as 100×100, 200×200.

The designation screen 150 is furthermore provided with three radio switch 158 for selecting a degree of sharpness processing of an image, and two radio switch 159 for selecting a color expression scheme of image data. A degree of the sharpness processing of an image can be selected from among three levels of no-sharpness, sharpness weakened and sharpness enhanced. As a color expression scheme of image data, it can be selected from between an expression scheme by four colors of CMYK and an expression scheme by three colors of RGB. Here, as the expression scheme in the image data 61 stored in the image database server 22 shown in FIG. 1, it is assumed that the expression scheme by three colors of RGB is adopted. For this reason, only in the event that the expression scheme by four colors of CMYK is selected by the radio switch 159, image data is subjected to a data conversion so as to generate image data in which colors are expressed in accordance with the expression scheme by four colors of CMYK.

The designation screen 150 is still further provided with a real size sample display button 160 which causes a sample of an image subjected to the image processing according to the above-mentioned various sorts of instruction to be displayed with the image size actually provided, and a download button 161 for instructing a download of the image subjected to such image processing.

A member designates conditions of data conversion and image processing through the designation screen 150 (a step CS05 in FIG. 2). After the conditions, when the real size sample display button 160 is clicked (a step CS06 in FIG. 2), the retrieval server 21 in FIG. 1 causes the image conversion and image processing server 23 in FIG. 1 to execute the data processing corresponding to the designated image processing and apply further processing to the image data subjected to the data processing, so that a sample, which will be described later, is created and the sample is displayed by the browser (a step SS08 in FIG. 2).

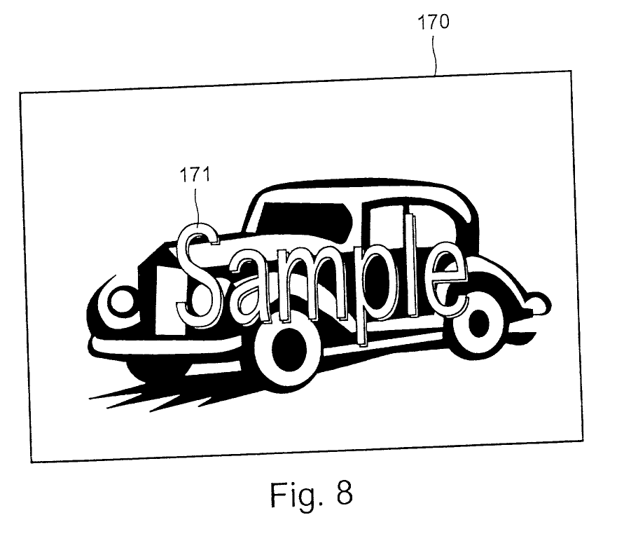

FIG. 8 is a view showing an example of a sample image.

A sample 170 of an image is subjected to image processing on the designated condition on the designation screen in FIG. 7, so that a member can check an image quality of the provided image through the sample 170. However, the sample 170 is synthesized with a character string 171 indicating a sample. Thus, it is impossible to use the sample 170 for an advertisement. As a scheme of indicating a sample, there are considered synthesis of marks and figures and setting up of broken portions other than synthesis of the character string 171.

After, a member checks the image quality through the sample 170, the process returns to the designation screen 150 in FIG. 7 using the function of the browser.

Incidentally, the above-mentioned step CS06 and step SS08 are executed only in the event that a member desires a confirmation by the sample and it is possible to omit those steps.

When the download button 161, which is provided on the designation screen 150 in FIG. 7, is clicked (a step CS07 in FIG. 2), the retrieval server 21 in FIG. 1 causes the browser to display an inquiry screen for a download so as to inquire of the member utilization information representative of the utilization form intended on the image to be downloaded, and requires a transmission of the utilization information in exchange for download of the image data (a step SS09 in FIG. 2). The retrieval server 21 serves as a utilization information request section referred to in the present invention.

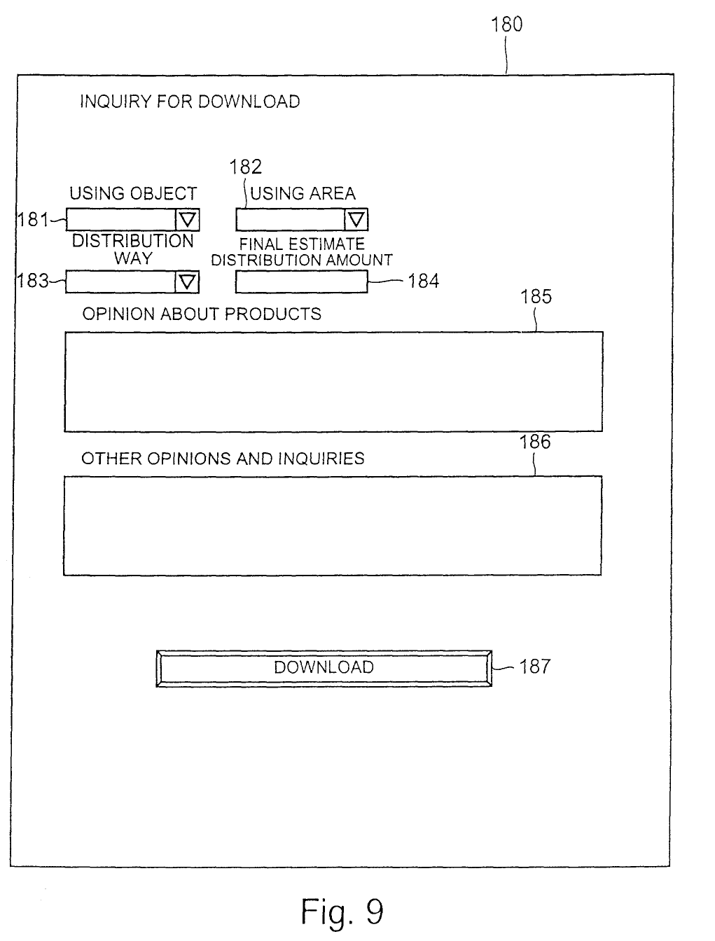

FIG. 9 is a view showing an inquiry screen for a download.

An inquiry screen 180 is provided with a using object selection box 181 into which a using object of an image is selectively entered. According to the present embodiment, it is to provide image data representative of an image for an advertisement, and thus, as the using object, for example, “handbills” and “catalogs” are selectable. The inquiry screen 180 is further provided with a using area selection box 182 in which an area, wherein an image is used for an advertisement, is selected from among prefecture names and area names and entered, and a distribution way selection box 183 in which a distribution way of handbills, wherein an image appears, is selected from among “a leaflet in a newspaper”, “a direct mail” and the like and entered. The inquiry screen 180 is furthermore provided with a final estimation distribution amount entry column 184 into which a distribution amount of image finally estimated is entered. Information entered through the using object selection box 181 corresponds to an example of the utilization information referred to in the present invention.

The inquiry screen 180 is still further provided with an opinion entry column 185 and an inquiry entry column 186. Members are able to enter their opinions and the like into those entry columns.

The inquiry screen 180 is still furthermore provided with a download button 187 for instructing a receipt of a download of the image in exchange for a transmission of utilization information such as the above-mentioned using object.

When utilization information is entered through the using object selection box 181 and the like, and the download button 187 is clicked (a step CS08 in FIG. 2), the utilization information is transmitted from the client to the retrieval server 21. The retrieval server 21 confirms whether necessary items are sufficiently provided in the transmitted utilization information (a step SS10 in FIG. 2). If it is decided that it is insufficient, the retrieval server 21 causes the browser of the client 50 to display the dialog that it is insufficient (a step SS11 in FIG. 2) and also to display the inquiry screen 180 of FIG. 9 again.

In the event that necessary items are sufficiently provided in the transmitted utilization information, the retrieval server 21 in FIG. 1 derives from the image database server 22 the profile 62 of the entry device for creating the image data 61, and attaches the profile 62 to image data and downloads the same on the client 50 (a step SS12 in FIG. 2). The retrieval server 21 serves as the data providing section referred to in the present invention.

The client 50, which is subjected to the download of the image data, terminates a series of operation for download.

On the other hand, the retrieval server 21, which has completed the download onto the client 50, records the utilization information transmitted from the client 50 on the table 70 stored in the image database server 22 (a step SS13 in FIG. 2), and terminates the operation of the site 20.

TABLE 1

| | | | | | | | | Final | |
|---|---|---|---|---|---|---|---|---|---|
| | | | | | | | | estimate | |
| Image | Product | File | Member's | Sizes of | Using | Using | Distribution | distribution | Utilization |
| Nos. | Nos. | names | IDs | images | objects | areas | ways | amount | dates |
| 0001 | 3456 | AAA | YAMADA | 141 × 100 | Catalog | All Japan | Store | 100 | 2000.08.15 |
| 0001 | 3456 | AAA | TANAKA | 200 × 141 | Handbill | Nagano | Leaflet in | 1000 | 2000.10.02 |
| | | | | | | prefecture | newspaper | | |
| 0002 | 3456 | BBB | SUZUKI | 141 × 100 | Handbill | Nagano | Leaflet in | 1500 | 2000.11.25 |
| | | | | | | prefecture | newspaper | | |
| 0002 | 3456 | BBB | YAMADA | 100 × 100 | Catalog | All over | Web | 10000 | 2000.12.11 |
| | | | | | | the | | | |
| | | | | | | world | | | |
| 0003 | 7890 | CCC | NAKAMURA | 200 × 141 | Catalog | Western | Direct mail | 2000 | 2000.12.14 |
| | | | | | | Japan | | | |

Table 1 shows an example of the table 70 stored in the image database server 22. In the image numbers column of Table 1, numbers of specifying images are entered, and in the product numbers column, numbers of products of images are entered. Further, in the file names column, the member's ID column, the image size column, the using objects column, the using areas column, the distribution ways column, the final estimate distribution amount column and the utilization date column, there are entered a file name of image data representative of an image, an ID number of a member onto whom image data is downloaded, an image size designated on the designation screen 150 in FIG. 7, the using object of an image, an area in which the use of an image is intended, a distribution way of an image, a distribution number of an image finally estimated, and a date on which image data is downloaded, respectively.

Utilization information entered in a table as shown in Table 1 is provided for a maker, who provides an operator of the site 20 in FIG. 1 with image data of high image quality, with charge or without charge, and is utilized in order that the maker grasps the utilization form of the image. The maker, who grasped the utilization form of the image by the member, is able to effectively advertise goods by providing the site with images easy for utilization for the member. Further, the maker grasps deviations in an area in which an image of goods is utilized, so that the maker is able to execute a unique advertisement in an area in which utilization of an image is less, and a concentrated business activities in an area in which utilization of an image is much.

Incidentally, Table 1 simply shows an example of utilization information and the utilization information referred to in the present invention is not restricted to one shown in Table 1.

Further, it is acceptable that the site of the embodiments as mentioned above is combined with an accounting system in which a download of image data is charged, or a system in which a download of image data is permitted without charge in exchange for providing detailed utilization information, or alternatively a system in which a member selects either one of charging and providing detailed utilization information.

Further, according to the above explanation, as medium for storing an image data providing program of the present invention, there is exemplarily shown a CD-ROM. It is acceptable, however, that the medium for storing an image data providing program of the present invention is a hard disk unit or a floppy disk.

As mentioned above, according to the present invention, it is possible to grasp a utilization form of the provided image.

While the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

What is claimed is:

1. An image data providing apparatus for providing image data representative of an image via a communication network comprising:
a utilization information request section for requesting of a request source generated a request of supply of image data, upon receipt of the request via the communication network, utilization information representative of a utilization form estimated on an image represented by image data requested by the request; and
a data providing section for providing image data required by the request generated from the request source, upon receipt of the utilization information requested by said utilization information request section from the request source, via the communication network to the request source.

2. An image data providing apparatus according to claim 1, wherein the image data is created by an input device for reading an original image to generate image data, and
said data providing section provides a profile defining an association between a color of the original image and a value of the image data in said input device, together with the image data.

3. An image data providing apparatus according to claim 1, wherein said image data providing apparatus further comprises:
a data processing section for applying data processing to image data in accordance with an instruction from the request source, and
wherein said data providing section provides the request source with the image data subjected to the data processing by said data processing section.

4. An image data providing apparatus according to claim 1, wherein said image data providing apparatus further comprises:
a data conversion section for performing a data conversion between first image data in which a color is represented by a first color space and second image data in which a color is represented by a second color space in accordance with a predetermined instruction from the request source, and
wherein said data providing section provides the request source with the image data subjected to the data conversion by said data conversion section.

5. An image data providing program storage medium storing an image data providing program which causes a computer to operate as an image data providing apparatus for providing image data representative of an image via a communication network, said image data providing apparatus comprising:
a utilization information request section for requesting of a request source generated a request of supply of image data, upon receipt of the request via the communication network, utilization information representative of a utilization form estimated on an image represented by image data requested by the request; and
a data providing section for providing image data required by the request generated from the request source, upon receipt of the utilization information requested by said utilization information request section from the request source, via the communication network to the request source.
